(19) United States
(12) Patent Application Publication
(10) Pub. No.: US 2008/0036937 A1
(43) Pub. Date: Feb. 14, 2008

(54) LIQUID CRYSTAL DISPLAY DEVICE AND METHOD FABRICATING THE SAME

(75) Inventor: Takehiro FUKUWAKI, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC LCD Technologies, Ltd, Kanagawa (JP)

(21) Appl. No.: 11/782,204

(22) Filed: Jul. 24, 2007

(30) Foreign Application Priority Data
Aug. 9, 2006 (JP) 2006-217253

(51) Int. Cl. G02F 1/1333

(52) U.S. Cl. 349/58

(57) ABSTRACT

A liquid crystal display device includes a liquid crystal display panel, a case in which the liquid crystal display panel is mounted, and which is comprised of a front case disposed at the front, and a rear case disposed at the rear, and an electrical conductor through which the front case is electrically conducted with the liquid crystal display panel. The electrical conductor is mounted on an inner surface of the front wall of the front case. The front case is formed with at least one slit such that deformation caused in a second area of the sidewall of the front case in which a connector for connecting to the rear case is formed, when the front case and the rear case are assembled to each other, does not extend to a first area in which the electrical connector is fixed to the front case.

### BACKGROUND OF THE INVENTION

1. Field of the Invention

The invention relates to a liquid crystal display device, a method of fabricating the same, and a front case used in the same.

2. Description of the Related Art

In a liquid crystal display device, if a front case constituting a part of a liquid crystal display device and being disposed at the front of the liquid crystal display device is electrically charged at a surface thereof, an electric field applied to liquid crystal included in the liquid crystal display device is caused to vary, resulting in irregularity in displaying images.

In order to avoid such irregularity in displaying images, a liquid crystal display panel and a front case may be electrically connected through an electrical conductor to render them in the same voltage for discharging static electricity therefrom.

For instance, Japanese Patent Application Publication No. 4-83224 (published on March 1992) has suggested a liquid crystal display device including a front case, a liquid crystal display panel, and electrically conductive rubber through which the front case and the liquid crystal display panel are electrically connected to each other.

There has been suggested a liquid crystal display device including a front case, a liquid crystal display panel, and a metal piece through which the front case and the liquid crystal display panel are electrically connected to each other.

There has been suggested a liquid crystal display device including a liquid crystal display panel, and a case in which the liquid crystal display device is mounted. The case is comprised of a front case comprised of a half-case opening towards a rear, and a rear case comprised of a rear case disposed at the rear of the liquid crystal display panel and comprised of a half-case opening towards a front. The front and rear cases are assembled to each other to thereby define the case.

In the suggested liquid crystal display device, the front and rear cases are assembled to each other, for instance, by inserting a projection formed on a sidewall of the rear case, into an opening formed at a sidewall of the front case.

Japanese Utility Model Application Publication No. 2-91397 (published on July 1990) has suggested a shield case comprising an upper half-case and a lower half-case both comprised of a thin metal plate. The upper and lower half-cases are formed at sidewalls thereof with a plurality of slits. The upper and lower half-cases are assembled to each other by joining the sidewalls of the upper and lower half-cases through the slits.

Japanese Patent Application Publication No. 11-17376 (published on January 1999) has suggested a shield case including a first shield part which is recessed and which has a projection on an outer surface, and a second shield part which is recessed and which has a hook at a sidewall thereof, which is engagable with the projection. The second shield part is formed with slits at opposite sides about the hook. The slits extend to an upper surface of the second shield part.

Since a liquid crystal display device is recently requested to have a large screen without increasing a size of a case, a case is likely to have a narrow width, in other words, a case is likely to be in the form of a narrow frame.

However, since an area to which electrically conductive rubber is adhered is relatively large in a liquid crystal display device in which a front case and a liquid crystal display panel are electrically connected to each other through the electrically conductive rubber as suggested in the above-mentioned Japanese Patent Application Publication No. 4-83224, it would not be possible to have the relatively large area in such a narrow-framed case.

Hence, in order to allow a case to be in the form of a narrow frame, a liquid crystal display panel and a front case are often electrically connected to each other through a metal piece. Furthermore, such a metal piece is necessary to be formed small, because the metal piece has to be hidden behind a frame defined by a front case.

Furthermore, if a frame defined by a case were small in width, a distance between an end of a liquid crystal display panel and an end of a case would be small, and accordingly, an area in which a liquid crystal display panel and a metal piece make contact with each other would be small. Accordingly, it is necessary to cause a liquid crystal display panel and a metal piece to surely make contact with each other.

Specifically, for instance, if a front case and a rear case are assembled to each other by inserting a projection formed on an outer surface of a sidewall of the rear case, into an opening formed in a sidewall of the front case, since the front case to which a metal piece is fixed is elastically deformed when assembled with the rear case, there might be caused a problem that the metal piece unintentionally “submerges” to a sidewall of a liquid crystal display panel, and accordingly, fails to electrically connect the front case and the liquid crystal display panel to each other.

### SUMMARY OF THE INVENTION

In view of the above-mentioned problems in the related art, it is an exemplary object of the present invention to provide a liquid crystal display panel which is capable of surely electrically connecting a front case and a liquid crystal display panel to each other through an electrical conductor such as a metal piece.

In a first exemplary aspect of the present invention, there is provided a liquid crystal display device including a liquid crystal display panel, a case in which the liquid crystal display panel is mounted, and which is comprised of a front case disposed at the front, and a rear case disposed at the rear, and an electrical conductor through which the front case is electrically conducted with the liquid crystal display panel, the front case being comprised of a half-case opening toward a rear of the liquid crystal display device, and being formed at a front wall thereof with an opening through which a display screen of the liquid crystal display panel is exposed, the rear case being comprised of a half-case opening towards a front of the liquid crystal display device, the electrical conductor being mounted on an inner surface of the front wall of the front case, the front case being formed with a first connector at a sidewall thereof disposed obliquely to a first area of the front wall of the front case in which the electrical conductor is mounted, the rear case being formed at a sidewall thereof with a second connector, the front case and the rear case being assembled with each other by connecting the first and second connectors to each other, the front case being formed with at least one slit such that deformation caused in a second area of the sidewall of the front case in which the first connector is formed, when the front case and the rear case are assembled to each other, does not extend to the first area.

In a second exemplary aspect of the present invention, there is provided a front case used in a liquid crystal display device including a liquid crystal display panel, and a case in which the liquid crystal display panel is mounted, the front case cooperating with a rear case to define the case, the front case including an electrical conductor through which the front case is electrically conducted with the liquid crystal display panel, the front case being comprised of a half-case opening toward a rear of the liquid crystal display device, and being formed at a front wall thereof with an opening through which a display screen of the liquid crystal display panel is exposed, the rear case being comprised of a half-case opening towards a front of the liquid crystal display device, the electrical conductor being mounted on an inner surface of the front wall of the front case, the front case being formed with a first connector at a sidewall thereof disposed obliquely to a first area of the front wall of the front case in which the electrical conductor is mounted, the rear case being formed at a sidewall thereof with a second connector, the front case and the rear case being assembled with each other by connecting the first and second connectors to each other, the front case being formed with at least one slit such that deformation caused in a second area of the sidewall of the front case in which the first connector is formed, when the front case and the rear case are assembled to each other, does not extend to the first area.

In a third exemplary aspect of the present invention, there is provided a method of fabricating a liquid crystal display device including a liquid crystal display panel, a case in which the liquid crystal display panel is mounted, and which is comprised of a front case disposed at the front, and a rear case disposed at the rear, and an electrical conductor through which the front case is electrically conducted with the liquid crystal display panel, the front case being comprised of a half-case opening toward a rear of the liquid crystal display device, and being formed at a front wall thereof with an opening through which a display screen of the liquid crystal display panel is exposed, the rear case being comprised of a half-case opening towards a front of the liquid crystal display device, the electrical conductor being mounted on an inner surface of the front wall of the front case, the front case being formed with a first connector at a sidewall thereof disposed obliquely to a first area of the front wall of the front case in which the electrical conductor is mounted, the rear case being formed at a sidewall thereof with a second connector, the front case and the rear case being assembled with each other by connecting the first and second connectors to each other, the method including forming at least one slit at the front case such that deformation caused in a second area of the sidewall of the front case in which the first connector is formed, when the front case and the rear case are assembled to each other, does not extend to the first area, and connecting the first and second connectors to each other to assemble the front and rear cases with each other.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a perspective view of a liquid crystal display panel in accordance with a first embodiment of the present invention.

FIG. 2 is a cross-sectional view taken along the line A-A in FIG. 1.

FIG. 3 is a cross-sectional view taken along the line B-B in FIG. 1.

FIG. 4 is a cross-sectional view taken along the line B-B in FIG. 1 in a liquid crystal display device in accordance with a variant of the first embodiment.

FIG. 5 is a perspective view of a liquid crystal display device in accordance with a second embodiment of the present invention.

FIG. 6 is a cross-sectional view taken along the line B-B in FIG. 5.

### DESCRIPTION OF THE EXEMPLARY EMBODIMENTS

Exemplary embodiments in accordance with the present invention will be explained hereinbelow with reference to drawings.

### First Exemplary Embodiment

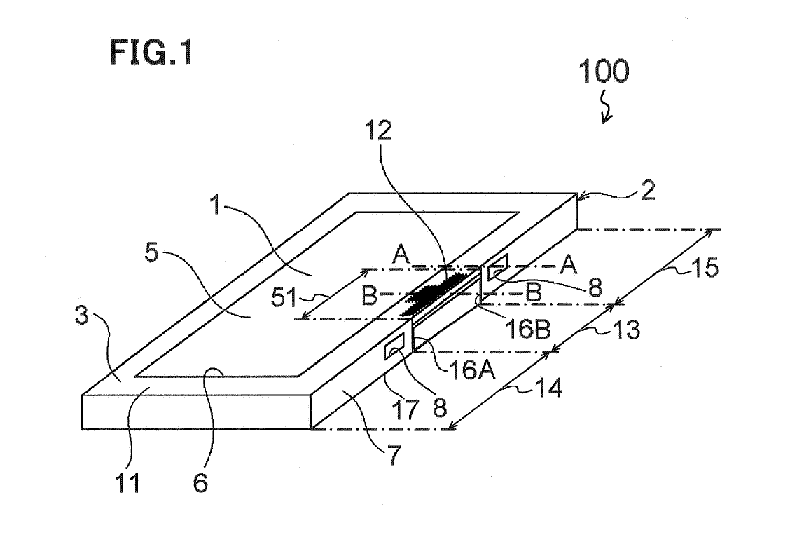

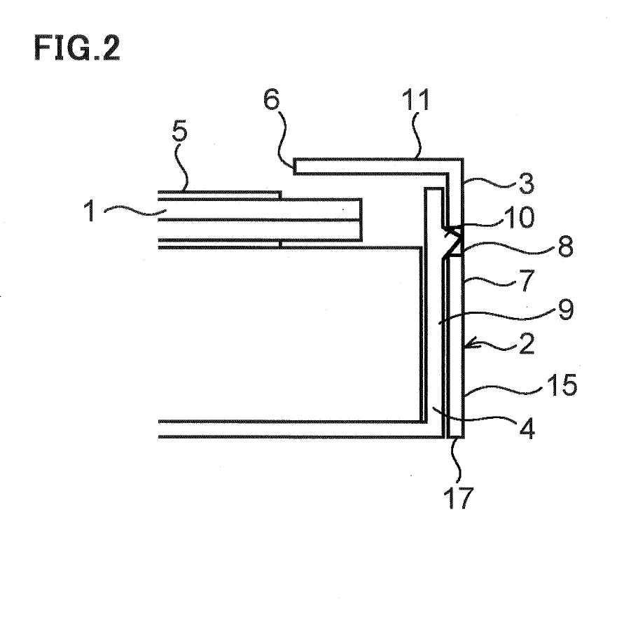

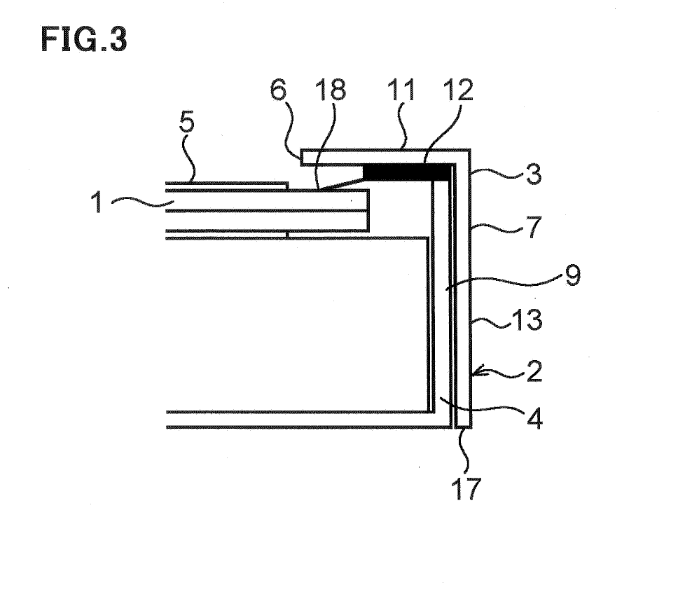

FIG. 1 is a perspective view of a liquid crystal display panel 100 in accordance with a first embodiment of the present invention, FIG. 2 is a cross-sectional view taken along the line A-A in FIG. 1, and FIG. 3 is a cross-sectional view taken along the line B-B in FIG. 1.

As illustrated in FIGS. 1 to 3, the liquid crystal display device 100 is comprised of a liquid crystal display panel 1 including a driver (not illustrated) for driving the liquid crystal display panel 1, and a substrate (not illustrated) for processing signals, and displaying images therein, and a case 2 in which the liquid crystal display panel 1 is encased.

The case 2 is comprised of a front case 3 disposed at the front of the liquid crystal display device 100, and a rear case 4 disposed at the rear of the liquid crystal display device 100.

For instance, the front case 3 and the rear case 4 are composed of metal.

The front case 3 is comprised of a half-case opening toward a rear of the liquid crystal display device 100, and is formed at a front wall 11 thereof with an opening 6 through which a display screen 5 of the liquid crystal display panel 1 is exposed.

The rear case 4 is comprised of a half-case opening towards a front of the liquid crystal display device 100.

The front case 3 and the rear case 4 are assembled to each other to thereby define the case 2, for instance, by inserting four sidewalls of the rear case 4 inwardly into four sidewalls of the front case 3, as illustrated in FIGS. 2 and 3.

As illustrated in FIG. 2, the front case 3 is formed at a sidewall 7 thereof with a first connector comprised of an opening 8, and the rear case 4 is formed at a sidewall 9 thereof with a second connector comprised of a projection 10 insertable into the opening 8 when the front case 3 and the rear case 4 are assembled to each other.

Specifically, the front case 3 is formed at the sidewall 7 thereof with a pair of openings 8 spaced away from each other in a longitudinal direction of the sidewall 7.

The rear case 4 is formed at the sidewall 9 thereof with a pair of projections 10 which are in alignment with the openings 8 when the front case 3 and the rear case 4 are assembled to each other.

After the front case 3 and the rear case 4 have been assembled to each other, since the projections 10 of the rear case 4 are inserted into the openings 8 of the front case 3, the front case 3 and the rear case 4 are kept assembled to each other under sufficient joint force.

An electrical conductor comprised of a metal piece 12 and through which the front case 3 is electrically conducted with the liquid crystal display panel 1 is fixed onto an inner surface of the front wall 11 of the front case 3.

Specifically, the metal piece 12 is fixed in an area of the front wall 11 obliquely facing the sidewall 7 of the front case 3.

By electrically connecting the front case 3 and the liquid crystal display panel 1 through the metal piece 12, the case 2 is kept to have the same voltage as that of the liquid crystal display panel 1.

The metal piece 12 has spring-characteristics. This is because the metal piece 12 is caused to surely make contact with the liquid crystal display panel 1, and further because the metal piece 12 makes contact with the liquid crystal display panel 1 under an appropriate contact pressure, since there is caused irregularity in displaying images due to breakage and/or deformation of the liquid crystal display panel 1, if the metal piece 12 makes contact with the liquid crystal display panel under a pressure which is too high.

As illustrated in FIG. 1, a first area 51 in which the metal piece 12 is fixed onto the front wall 11 of the front case 3 is sandwiched between a pair of the openings 8.

As illustrated in FIG. 1, the sidewall 7 of the front case 3 is comprised of a pair of second areas 14 and 15 in each of which the opening 8 is formed, and a third area 13 obliquely facing the first area 51 (an area in which the metal piece 12 is fixed onto the front wall 11 of the front case 3). The front case 3 is formed with a first slit 16A between the second area 14 and the third area 13 and further with a second slit 16B between the second area 15 and the third area 13.

The first and second slits 16A and 16B are formed at the sidewall 7 of the front case 3 because deformation caused in the second areas 14 and 15 of the sidewall 7 of the front case 3 in which the openings 8 as the first connectors are formed does not extend to the first area 51 when the front case 3 and the rear case 4 are assembled to each other.

For instance, the slits 16A and 16B extend vertically at the sidewall 7 of the front case 3 between an opening end 17 of the front case 3 and a front end of the front case 3 (that is, the front wall 11 of the front case 3).

That is, a longitudinal direction in which the slits 16A and 16B extend is perpendicular to a plane defined by the display screen 5 of the liquid crystal display panel 1.

Hereinbelow is explained a method of fabricating the liquid crystal display device 100.

As illustrated in FIG. 1, the front case 3 is in advance formed at the sidewall 7 thereof with the first slit 16A between the third area 13 facing the first area 51 in which the metal piece 12 is fixed to the front wall 11 of the front case 3, and the second area 14 in which the opening 8 is formed, and further with the second slit 16B between the third area 13 and the second area 15 in which the opening 8 is formed.

Then, the liquid crystal display panel 1 mounted in the rear case 4 such that the display screen 5 of the liquid crystal display panel 1 faces forwardly.

Then, the rear case 4 and the front case 3 are assembled to each other.

Specifically, the front case 3 and the rear case 4 are assembled to each other by inserting four sidewalls of the rear case 4 inwardly into four sidewalls of the front case 3, as illustrated in FIGS. 2 and 3.

By assembling the rear case 4 and the front case 3 to each other, the projections 8 formed at the sidewall 9 of the rear case 4 are inserted into the openings 8 formed at the sidewall 7 of the front case 3, and the display screen 5 of the liquid crystal display panel 1 is exposed forwardly through the opening 6 of the front case 3.

Furthermore, by assembling the rear case 4 and the front case 3 to each other, the metal piece 12 makes contact at a tip end thereof with an electrical conductor 18 of the liquid crystal display panel 1 to ensure that the front case 3 and the liquid crystal display panel 1 are electrically connected to each other through the metal piece 12.

Since the metal piece 12 has spring-characteristics, after the rear case 4 and the front case 3 have been assembled to each other, the metal piece 12 is compressed onto the liquid crystal display panel 1 with an appropriate contact pressure against a repulsion force of the metal piece 12.

When the rear case 4 and the front case 3 are assembled to each other, the second areas 14 and 15 of the sidewall 7 of the front case 3 in each of which the opening 8 is formed deform and accordingly expand outwardly due to the projections 10 of the rear case 4. However, since the third area 13 obliquely facing the first area 51 in which the metal piece 12 is fixed to the front wall 11 of the front case 3 is separated from the second areas 14 and 15 through the first and second slits 16A and 16B, the third area 13 does not expand outwardly.

Accordingly, the deformation caused in the second areas 14 and 15 does not extend to the first area 51 in which the metal piece 12 is fixed to the front wall 11 of the front case 3, obliquely facing the third area 13.

Thus, it is possible to avoid the metal piece 12 from not appropriately making contact with the electrical conductor 18 of the liquid crystal display panel 1 with the result of defectiveness in displaying images, since the metal piece 12 surely makes contact at a tip end thereof with the electrical conductor 18 of the liquid crystal display panel 1, when the rear case 4 and the front case 3 are assembled to each other.

The liquid crystal display device 100 in accordance with the first embodiment provides the following advantages.

The first advantage is that it is possible to prevent the deformation caused in the second areas 14 and 15 from extending to both the third area 13 and the first area 51 in which the metal piece 12 is fixed to the front case 3, obliquely facing the third area 13, when the rear case 4 and the front case 3 are assembled to each other, by virtue of the first and second slits 16A and 16B formed at the sidewall 7 of the front case 3. Thus, it is possible to accurately position the metal piece 12 at the electrical conductor 18 of the liquid crystal display panel 1.

The second advantage is that it is possible to provide a liquid crystal display device which is in the form of a narrow frame by virtue of the above-mentioned first advantage.

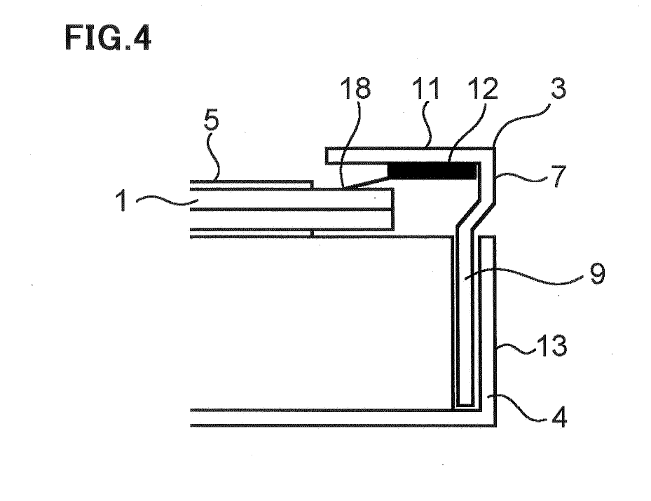

FIG. 4 is a cross-sectional view taken along the line B-B in FIG. 1 in a liquid crystal display device in accordance with a variant of the above-mentioned first embodiment.

As illustrated in FIG. 4, the third area 13 of the sidewall 7 of the front case 3 is bent so as to be insertable inwardly into the sidewall 9 of the rear case 4. Thus, after the rear case 4 and the front case 3 have been assembled to each other, the third area 13 of the sidewall 7 of the front case 3 is situated inwardly of the sidewall 9 of the rear case 4.

The variant illustrated in FIG. 4 provides a greater strength for assembling the front case 3 and the rear case 4 to each other than a strength for assembling the front case 3 and the rear case 4 to each other in the structure illustrated in FIG. 3.

### Second Exemplary Embodiment

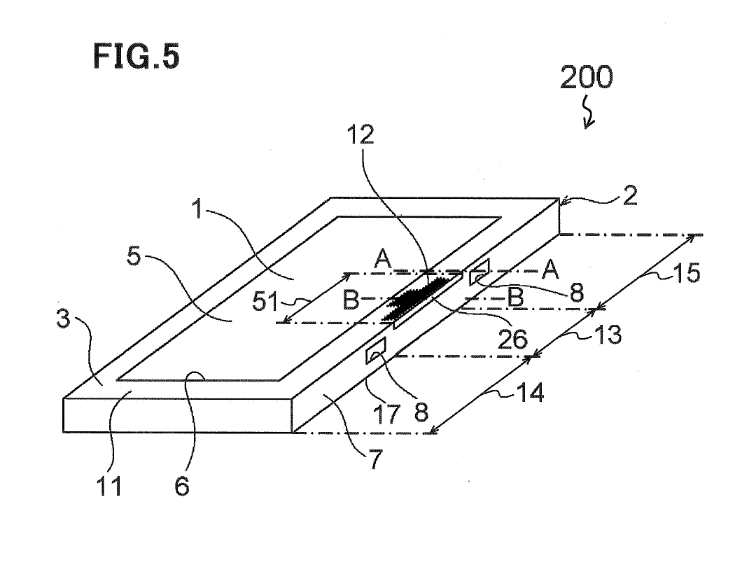

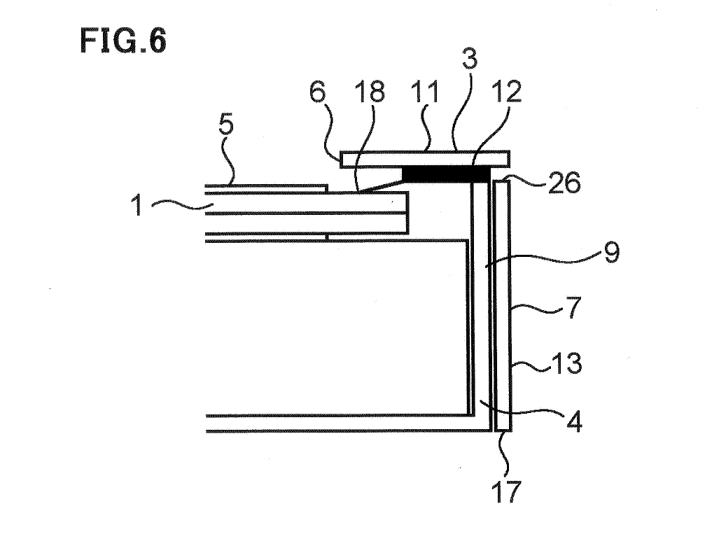

FIG. 5 is a perspective view of a liquid crystal display device 200 in accordance with a second embodiment of the present invention, and FIG. 6 is a cross-sectional view taken along the line B-B in FIG. 5.

In the second embodiment, a cross-sectional view taken along the line A-A is identical with FIG. 2, that is, a cross-sectional view taken along the line A-A in FIG. 1.

Whereas the front case 3 in the first embodiment is formed at the sidewall 7 thereof with the first and second slits 16A and 16B both vertically extending, the front case 3 in the second embodiment is formed at the sidewall 7 thereof with a horizontally extending slit 26.

In the above-mentioned first embodiment, the first slit 16A is formed at the sidewall 7 of the front case 3 between the second area 14 and the third area 13, and the second slit 16B is formed at the sidewall 7 of the front case 3 between the second area 15 and the third area 13. In contrast, in the second embodiment, the slit 26 horizontally extends between the third area 13 of the sidewall 7 of the front case 3 and the first area 51 in which the metal piece 12 is fixed to the front wall 11 of the front case 3 and which obliquely faces the third area 13.

In the liquid crystal display device 200 in accordance with the second embodiment, as illustrated in FIG. 5 and 6, the front case 3 is formed at the sidewall 7 thereof with the slit 26 between the first area 51 of the front wall 11 of the front case 3 and the third area 13. The slit 26 extends in a longitudinal direction in parallel with a plane defined by the display screen 5 of the liquid crystal display panel 1.

A method of fabricating the liquid crystal display device 200 in accordance with the second embodiment is identical with the method of fabricating the liquid crystal display device 100 in accordance with the first embodiment except that the slit 26 is formed at the sidewall 7 of the front case 3 in place of the first and second slits 16A and 16B.

In the second embodiment, when the front case 3 and the rear case 4 are assembled to each other, the second areas 14 and 15 of the sidewall 7 of the front case 3 in each of which the opening 8 is formed deform, that is, expand outwardly due to the projections 10 of the rear case 4, and accordingly, the third area 3 of the sidewall 7 of the front case 3 slightly deforms, that is, slightly expands outwardly.

However, since the slit 26 is formed between the third area 13 and the front wall 11 of the front case 3, it is possible to prevent the deformation of the third area 13 from extending to the first area 51 of the front case 3 in which the metal piece 12 is fixed to the front wall 11 of the front case 3.

Thus, it is possible to avoid the metal piece 12 from not appropriately making contact with the electrical conductor 18 of the liquid crystal display panel 1 with the result of defectiveness in displaying images, since the metal piece 12 surely makes contact at a tip end thereof with the electrical conductor 18 of the liquid crystal display panel 1, when the rear case 4 and the front case 3 are assembled to each other.

The liquid crystal display device 200 in accordance with the second embodiment provides the following advantages.

The first advantage is that it is possible to prevent the deformation of the third area 13 caused by the deformation of the second areas 14 and 15 from extending to the first area 51 in which the metal piece 12 is fixed to the front case 3, obliquely facing the third area 13, when the rear case 4 and the front case 3 are assembled to each other, by virtue of the slit 26 formed at the sidewall 7 of the front case 3. Thus, it is possible to accurately position the metal piece 12 at the electrical conductor 18 of the liquid crystal display panel 1.

The second advantage is that it is possible to provide a liquid crystal display device which is in the form of a narrow frame by virtue of the above-mentioned first advantage.

In the above-mentioned first and second embodiments, the front case 3 is formed at the sidewall 7 thereof with the openings 8, and the rear case 4 is formed at the sidewall 9 thereof with the projections 10. In contrast, the front case 3 may be formed at the sidewall 7 thereof with the projections 10, and the rear case 4 may be formed at the sidewall 9 thereof with the openings 8.

In place of the openings 8 into which the projections 10 are inserted, the front case 3 may be formed at the sidewall 7 thereof with a recess into which the projections 10 are insertable, or the rear case 4 may be formed at the sidewall 9 thereof with a recess into which the projections 10 are insertable.

In accordance with the above-mentioned exemplary embodiments, since the front case 3 is formed with the slits 16A and 16B or the slit 26, when the front case 3 and the rear case 4 are assembled to each other by connecting the first and second connectors 8 and 10 to each other, it would be possible to prevent the deformation caused in the second areas 14 and 15 (namely, an area in which the first connector 8 is formed at the sidewall 7 of the front case 3) from extending to the first area 51 (namely, an area in which the electrical conductor 12 is attached to the front case 3).

Accordingly, since the electrical conductor 12 is compressed onto the liquid crystal display panel 1 at a desired position without being deformed, it is possible to preferably electrically connect the front case 3 and the liquid crystal display panel 1 through the electrical conductor 12. That is, there is not caused the above-mentioned problem that the metal piece unintentionally “submerges” to a sidewall of the liquid crystal display panel, and accordingly, fails to electrically connect the front case and the liquid crystal display panel to each other. It is surely possible to electrically connect the front case 3 and the liquid crystal display panel 1 to each other through the electrical conductor 12.

In the liquid crystal display device in accordance with the present invention, it is preferable that the front case is formed with a pair of first connectors each in second areas, in which case, the slit is formed at the sidewall of the front case between a third area obliquely facing the first area and one of the second areas, and further between the third area and the other of the second areas, respectively.

In the liquid crystal display device in accordance with the present invention, it is preferable that the slit extends vertically at the sidewall of the front case between an opening end of the front case and a front end of the front case.

In the liquid crystal display device in accordance with the present invention, it is preferable that the slit extend horizontally between a third area obliquely facing the first area and the first area.

In the liquid crystal display device in accordance with the present invention, it is preferable that one of the first and second connectors is comprised of an opening or a recess, and the other is comprised of a projection insertable into the opening or the recess.

In the liquid crystal display device in accordance with the present invention, it is preferable that the front case is formed at the sidewall thereof with a pair of first connectors such that the first connectors sandwich the first area therebetween.

In the liquid crystal display device in accordance with the present invention, it is preferable that the electrical conductor has spring-characteristic, the electrical conductor being compressed onto the liquid crystal display panel against a repulsion force of the electrical conductor when the front case and the rear case are assembled to each other.

In the liquid crystal display device in accordance with the present invention, the electrical conductor may be comprised of a metal piece, for instance.

In the front case in accordance with the present invention, it is preferable that the front case is formed with a pair of first connectors each in second areas, in which case, the slit is formed at the sidewall of the front case between a third area obliquely facing the first area and one of the second areas, and further between the third area and the other of the second areas, respectively.

In the front case in accordance with the present invention, it is preferable that the slit extends vertically at the sidewall of the front case between an opening end of the front case and a front end of the front case.

In the front case in accordance with the present invention, it is preferable that the slit extend horizontally between a third area obliquely facing the first area and the first area.

In the front case in accordance with the present invention, it is preferable that the front case is formed at the sidewall thereof with a pair of first connectors such that the first connectors sandwich the first area therebetween.

In the front case in accordance with the present invention, it is preferable that the electrical conductor has spring-characteristic, the electrical conductor being compressed onto the liquid crystal display panel against a repulsion force of the electrical conductor when the front case and the rear case are assembled to each other.

In the front case in accordance with the present invention, for instance, the electrical conductor may be comprised of a metal piece.

The exemplary advantages obtained by the above-mentioned exemplary embodiments are described hereinbelow.

While the present invention has been described in connection with certain exemplary embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

This application is based upon and claims the benefit of priority from Japanese Patent Application No. 2006-217253 filed on Aug. 9, 2006, the entire disclosure of which, including specification, claims, drawings and summary, is incorporated herein by reference in its entirety.

What is claimed is:

1. A liquid crystal display device comprising:
a liquid crystal display panel;
a case in which said liquid crystal display panel is mounted, and which is comprised of a front case disposed at the front, and a rear case disposed at the rear; and
an electrical conductor through which said front case is electrically conducted with said liquid crystal display panel,
said front case being comprised of a half-case opening toward a rear of said liquid crystal display device, and being formed at a front wall thereof with an opening through which a display screen of said liquid crystal display panel is exposed,
said rear case being comprised of a half-case opening towards a front of said liquid crystal display device,
said electrical conductor being mounted on an inner surface of said front wall of said front case,
said front case being formed with a first connector at a sidewall thereof disposed obliquely to a first area of said front wall of said front case in which said electrical conductor is mounted,
said rear case being formed at a sidewall thereof with a second connector, said front case and said rear case being assembled with each other by connecting said first and second connectors to each other,
said front case being formed with at least one slit such that deformation caused in a second area of said sidewall of said front case in which said first connector is formed, when said front case and said rear case are assembled to each other, does not extend to said first area.

2. The liquid crystal display device as set forth in claim 1, wherein said front case is formed with a pair of first connectors each in second areas,
said slit being formed at said sidewall of said front case between a third area obliquely facing said first area and one of said second areas, and further between said third area and the other of said second areas, respectively.

3. The liquid crystal display device as set forth in claim 2, wherein said slit extends vertically at said sidewall of said front case between an opening end of said front case and a front end of said front case.

4. The liquid crystal display device as set forth in claim 1, wherein said slit extend horizontally between a third area obliquely facing said first area and said first area.

5. The liquid crystal display device as set forth in claim 1, wherein one of said first and second connectors is comprised of an opening or a recess, and the other is comprised of a projection insertable into said opening or said recess.

6. The liquid crystal display device as set forth in claim 1, wherein said front case is formed at said sidewall thereof with a pair of first connectors such that said first connectors sandwich said first area therebetween.

7. The liquid crystal display device as set forth in claim 1, wherein said electrical conductor has spring-characteristic, said electrical conductor being compressed onto said liquid crystal display panel against a repulsion force of said electrical conductor when said front case and said rear case are assembled to each other.

8. The liquid crystal display device as set forth in claim 1, wherein said electrical conductor is comprised of a metal piece.

9. A front case used in a liquid crystal display device comprising a liquid crystal display panel, and a case in which said liquid crystal display panel is mounted,
said front case cooperating with a rear case to define said case,
said front case including an electrical conductor through which said front case is electrically conducted with said liquid crystal display panel,
said front case being comprised of a half-case opening toward a rear of said liquid crystal display device, and being formed at a front wall thereof with an opening through which a display screen of said liquid crystal display panel is exposed, said rear case being comprised of a half-case opening towards a front of said liquid crystal display device,
said electrical conductor being mounted on an inner surface of said front wall of said front case,
said front case being formed with a first connector at a sidewall thereof disposed obliquely to a first area of said front wall of said front case in which said electrical conductor is mounted, said rear case being formed at a sidewall thereof with a second connector, said front case and said rear case being assembled with each other by connecting said first and second connectors to each other,
said front case being formed with at least one slit such that deformation caused in a second area of said sidewall of said front case in which said first connector is formed, when said front case and said rear case are assembled to each other, does not extend to said first area.

10. The front case as set forth in claim 9, wherein said front case is formed with a pair of first connectors each in second areas,
said slit being formed at said sidewall of said front case between a third area obliquely facing said first area and one of said second areas, and further between said third area and the other of said second areas, respectively.

11. The front case as set forth in claim 10, wherein said slit extends vertically at said sidewall of said front case between an opening end of said front case and a front end of said front case.

12. The front case as set forth in claim 9, wherein said slit extend horizontally between a third area obliquely facing said first area and said first area.

13. The front case as set forth in claim 9, wherein said front case is formed at said sidewall thereof with a pair of first connectors such that said first connectors sandwich said first area therebetween.

14. The front case as set forth in claim 9, wherein said electrical conductor has spring-characteristic, said electrical conductor being compressed onto said liquid crystal display panel against a repulsion force of said electrical conductor when said front case and said rear case are assembled to each other.

15. The front case as set forth in claim 9, wherein said electrical conductor is comprised of a metal piece.

16. A method of fabricating a liquid crystal display device comprising a liquid crystal display panel, a case in which said liquid crystal display panel is mounted, and which is comprised of a front case disposed at the front, and a rear case disposed at the rear, and an electrical conductor through which said front case is electrically conducted with said liquid crystal display panel,
said front case being comprised of a half-case opening toward a rear of said liquid crystal display device, and being formed at a front wall thereof with an opening through which a display screen of said liquid crystal display panel is exposed,
said rear case being comprised of a half-case opening towards a front of said liquid crystal display device,
said electrical conductor being mounted on an inner surface of said front wall of said front case,
said front case being formed with a first connector at a sidewall thereof disposed obliquely to a first area of said front wall of said front case in which said electrical conductor is mounted,
said rear case being formed at a sidewall thereof with a second connector, said front case and said rear case being assembled with each other by connecting said first and second connectors to each other,
said method comprising:
forming at least one slit at said front case such that deformation caused in a second area of said sidewall of said front case in which said first connector is formed, when said front case and said rear case are assembled to each other, does not extend to said first area; and
connecting said first and second connectors to each other to assemble said front and rear cases with each other.
